(19) United States
(12) Patent Application Publication
(10) Pub. No.: US 2005/0246275 A1
(43) Pub. Date: Nov. 3, 2005

(54) Real-time FBO management method & system

(76) Inventor: John Robert-Winfred Nelson, New Smyrna Beach, FL (US)

Correspondence Address: FRANK B. ARENAS, P. O. BOX 600, 2327 TAYLOR AVENUE, COLEMAN, FL, 33521, US

(21) Appl. No.: 10/862,697

(22) Filed: Jun. 7, 2004

Related U.S. Application Data
(60) Provisional application No. 60/567,395, filed on Apr. 30, 2004.

(51) Int. Cl. G06F 17/60

(52) U.S. Cl. 705/40

(57) ABSTRACT

An apparatus, system and method is disclosed that solves the needs in the art by providing an apparatus, method and system to accomplish transactions between aircraft customers (buyers) and FBO office (seller) to be sold, paid, billed and accounted in real-time, both remotely at the aircraft location on the airport by a remote operator and inside the FBO office by an inside operator.

### CROSS REFERENCE TO RELATED APPLICATION

This Nonprovisional application for patent incorporates by reference and claims the benefit of pending Provisional Application having Ser. No. 60/567395, filed Apr. 30, 2004 for “Real-Time FBO Management Method and System,” commonly owned with the instant application.

### COPYRIGHT NOTICE

A portion of the disclosure of this patent document, including Appendices, contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates generally to Fixed-Based-Operators (FBO) and management methods for day-to-day operations of a FBO on an airport. The invention particularly relates to sales, payment, management and accounting systems for selling fuel, services and products to aircraft owners or pilots of aircraft from fuel trucks on the airport ramp. The invention more particularly relates to using real-time computer-based methods for the above-referenced sales to include real-time wireless credit card authorization for payment and other types of payment/billing systems for payment from aircraft customers directly to the fuel truck operator. Other features of the invention include aircraft tracking, aircraft dispatching, generation of work orders, shop orders and many other features as disclosed in these specifications.

2. Description of the Prior Art

Since the early 1900s, the FBO industry has been to airplanes and aircraft what the gas station and car garage mechanic/repair services industry has been to automobiles (cars). Like cars, aircraft need fuel (and oil) to operate. Typically, aviation fuel consists of “Avgas” (100 LL, for example) for piston engine powered aircraft (similar to car gas) or “Jet-A fuel” for turbine or jet powered aircraft (more similar to kerosene). Other types of fuels are sometimes used for aircraft e.g. different octane ratings, etc., but virtually all are generally based on petroleum products. Also like cars, aircraft engines, airframes and other aircraft systems break or malfunction and need repairs and maintenance periodically and as needed when the specific break-down or malfunction occurs. The FBO typically offers repair services to aircraft from their A&P (airframe and powerplant) shops. Other services are also sometimes offered by the FBO, such as a school for flight training (primary instruction for students to obtain their own pilot's license under the Federal Aviation Regulations (FAR) or advanced training for licensed pilots in classroom ground schools and actual flight instruction in real aircraft and/or simulators), aircraft rentals, food catering, auxiliary-starts for engines, car rentals, hotel reservations, etc. and all related services.

When aircraft arrive at the ramp, the main FBO contact with the aircraft owners and/or pilots is the lineman (line service agent, sometimes referred to as a Customer Service Representative “CSR”) who also usually operates the fuel trucks to take fuel to the aircraft parked on the airport ramp (apron). The location of the aircraft to be fueled is usually remote from the FBO office. This requires the aircraft pilot to walk to the FBO office to pay for fuel, products and/or services rendered by the lineman. This is time consuming and inconvenient for the pilot, especially when on a tight flight schedule.

Over the years, the sales, billing, payment and accounting methods of the FBO industry have progressed from a simple paper form that is filled-out by the lineman and given to the pilot who then walks to the FBO office to pay to newer methods. These newer methods include computer-based software to track the above transactions and acceptance of credit cards for payment in addition to cash and commercial accounts for known customers with established credit at the FBO office.

In the aviation FBO industry, however, there currently exists no real-time (live) wireless credit card processing (or other medium of commerce) authorization and approval for payment system for use by the fuel truck operator (lineman) to complete a sales transaction at the fuel truck for aircraft fuel, products and/or services remotely at the aircraft location on the airport ramp.

Other systems of the prior art include Touch PC (www.touchpc.com; TouchStar Solutions, LLC, 5147 S. Garnett, Suite D, Tulsa, Okla. 74146, USA). This system links to the fuel meter on the truck and controls fuel flow. This system also allows the sale of other merchandise such as oil. There is no live (real-time) wireless capability to the software in this system; data are recorded and then synchronized at the end of the day. There is no credit card authorization capability with this system.

Another system is offered by Contrec-USA (http://www.contrec-usa.com/), 916 Belcher Dr. Pelham, Ala. 35124 USA. The device is in a box in the fuel truck and controls and tracks flow at the fuel truck. The fuel truck driver can print a ticket, enter a tail number, and track other aircraft information. It can receive data and store the fuel transaction as an open invoice in another software program. No live credit card processing is available with the device. No other products may be sold with the system, nor is it hand-held.

Yet another system is offered by Fuel Master Wingtip Fueler (http://www.syntech-fuelmaster.com), 100 Four Points Way, P.O. Box 5258, Tallahassee, Fla. 32305. In 1997, Fuel Master was only promoting their self-serve fueling system. By 2000, Fuel Master had developed a competitive, very similar system, to Contrec's application. Avitat Tallahassee made attempts to use the system, but dropped it due to lack of reliability. Petersen Aviation (So Cal) is currently using the system. No live credit card processing is available and no other products may be sold with the system.

Earlier versions of this method and system were developed by this same inventor in 1997, 1999 and 2003, but those versions do not include real-time (live) wireless credit card processing (or other medium of commerce) authorization and approval for payment system for use by the fuel truck operator (lineman) to complete a sales transaction at the fuel truck for aircraft fuel, products and/or services remotely at the aircraft location on the airport ramp, nor does it allow multi-user applications, as does the present invention.

U.S. Pat. No. 6,415,219 discloses “Technique of real-time tracking and management of land-based vehicles (LBV) of the airport” but the system uses GPS technology to keep track of the locations of fuel trucks, buses, baggage trucks, etc. and is designed mainly for security and safety (collision avoidance of the LBV with aircraft on the ramp).

### SUMMARY OF THE INVENTION

The present invention solves the needs in the art by providing an apparatus, method and system to accomplish transactions between aircraft customers (buyers) and FBO office (seller) to be sold, paid, billed and accounted in real-time, both remotely at the aircraft location on the airport and inside the FBO office.

Features of the invention can be implemented in several ways, including as system, a method and/or computer readable media having code devices for implementing the methods of the invention. The invention preferably includes a wireless communications infrastructure, wherein remote communications between the FBO office and FBO remote operator can be achieved. Several embodiments of the invention are discussed below. The invention can be implemented in other ways, including as a system (including a computer processing or database system), a method (including a computerized method of constructing a tree data structure and a method for evaluating queries), an apparatus, a computer readable medium, a computer program product, and/or a data structure tangibly fixed in a computer readable memory.

As a COMPUTER SYSTEM, an embodiment of the invention includes a database containing tables of data, a display device and a processor unit. The display device has a plurality of display areas (windows). The processor unit operates to access the database to retrieve the data from the corresponding associated tables and then display the retrieved data in the display areas.

As a GRAPHICAL USER INTERFACE (GUI) for a display screen of a computer, an embodiment of the invention includes a number of display areas (“windows”) for searching and displaying data. A variety of formats for searching and displaying data is provided. Searches can be performed by many parameters that are more fully disclosed below. Search results are graphically, textually and/or numerically displayed showing needed information pertinent to the FBO business and industry.

As a METHOD of displaying data on a display device of a computer system, the data being obtained from a relational database associated with the computer system, the display having “windowing” capability to provide a plurality of display areas, an embodiment of the invention includes the operations of remote and inside sales for an FBO office. The method further includes real-time sales and payment to a remote operator by a remote customer (with or without an aircraft) remote from the FBO office, for example on the airport ramp or other location on the airport premises.

As a COMPUTER READIBLE MEDIA containing program instructions for displaying data on a display device of a computer system, the data being obtained from a relational database associated with the computer system, the display having “windowing” capability to provide a plurality of display areas, an embodiment of the invention includes computer readable code devices for operator input, manipulation and output. The invention's database and transmission of data may also include an encryption means and password access to prevent access or interception from unauthorized users.

The methods of the present invention may be implemented as a computer program product with a computer-readable medium having code thereon. The program product includes a program and a signal bearing media bearing the program.

As an APPARATUS, the present invention may include at least one processor, a memory coupled to the processor, and a program residing in the memory which implements the methods of the present invention via a communication means. For example, the apparatus may include a remote input device with a sufficient amount of computer hardware, software, peripherals and necessities outside the FBO office capable of communicating with at least one host computer with a sufficient amount of computer hardware, software, peripherals and necessities inside the FBO office;

at least one database accessible to the host computer and the remote input device; a means for communicating in real-time between the remote input device and the host computer, and;

a means for communicating in real-time between the host computer and a credit card (including “branded” cards marketed by the avgas companies) payment authorization and/or approval source and/or other medium of commerce for any payment type from aircraft customer acceptable to seller, the FBO office.

The apparatus may further include a data interface and means of communicating between said remote input device and at least one fuel flow counter output, either in real-time or not. The apparatus may also include the remote input device with a viewing and touch-screen and a printer and credit card or other type magnetic card swiper.

The host computer may also include a computer network accessible to and in communication with a plurality of computers, either wired or wireless. The data and means for communication may be encrypted or un-encrypted (plaintext or ciphertext). The new method and system can track multiple remote users from multiple FBO offices, if desired.

It is an object of the invention to increase effectiveness and efficiency of manpower to FBO aviation businesses by allowing the fuel truck driver to provide aviation fuel, products and/or services to include real-time (live) remote payment via credit cards or other billing/payment types (e.g. open invoice, monthly billings to established customers, etc. or any other payment type based on user-defined criterion).

It is another object of this invention to streamline business processes by increasing field workforce productivity and accuracy. Another object of this invention is to reduce administration and data entry costs for those in the FBO aviation industry. Yet another object of this invention is to increase aircraft customer satisfaction by allowing pilots to receive fuel, products, and/or services and afforded the convenience to pay at the remote aircraft location. This invention eliminates the pilot's need to spend more time and inconvenience by having to go to the FBO physical office location to pay.

The objects of this invention are achieved and the present invention provides a new and useful apparatus, method and system for real-time FBO payment, billing, management and accounting. This new and useful real-time FBO management apparatus, method and system invention solves this and other aviation FBO industry payment, billing, management and accounting problems in a safe, economical and more efficient manner than that of the prior art.

All patents, patent applications, provisional applications and publications referred to or cited herein, or from which a claim for benefits of priority has been made, are incorporated herein by reference in their entirety to the extent they are not inconsistent with the explicit teachings of this specification.

### BRIEF DESCRIPTION OF THE DRAWINGS

In the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic drawing of the apparatus and system components.

FIG. 2 is a schematic drawing of a typical Remote Sales Cycle (RSC) method as viewed by the remote operator.

FIG. 3 is a schematic drawing of a typical Remote Sales Cycle method relative to the system components and interaction.

FIG. 4 is a schematic drawing of the Inside Sales Cycle (ISC) method as viewed by the inside operator.

FIG. 5 is a schematic and flowchart for the remote input device software (PocketFuel) and method.

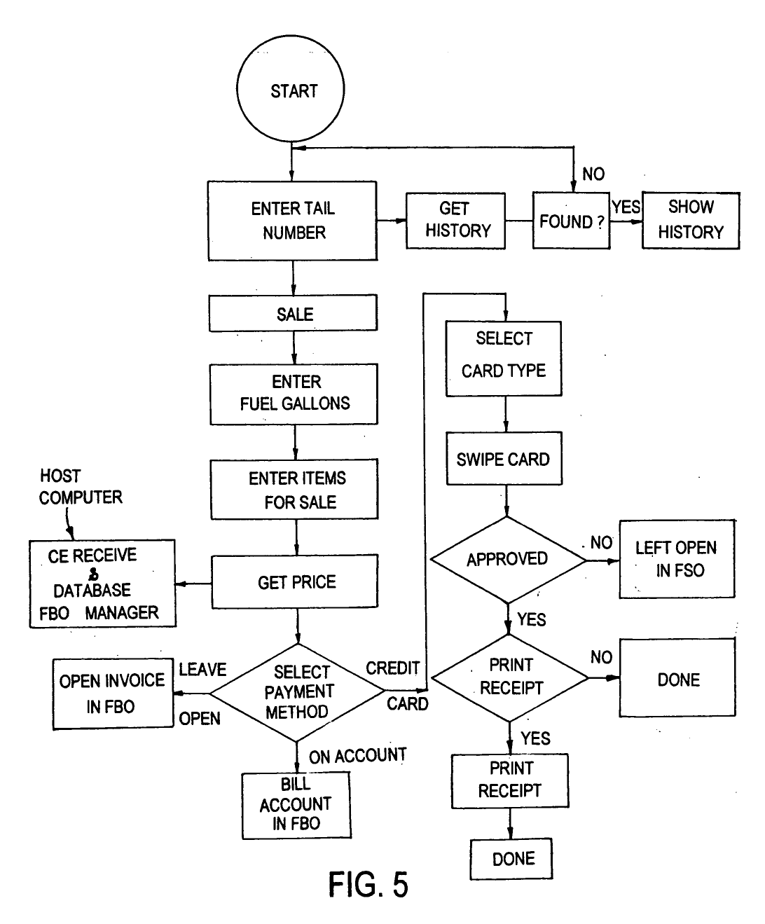

FIG. 6 is a schematic and flowchart for the host computer software (FBO Manager 2004) and method.

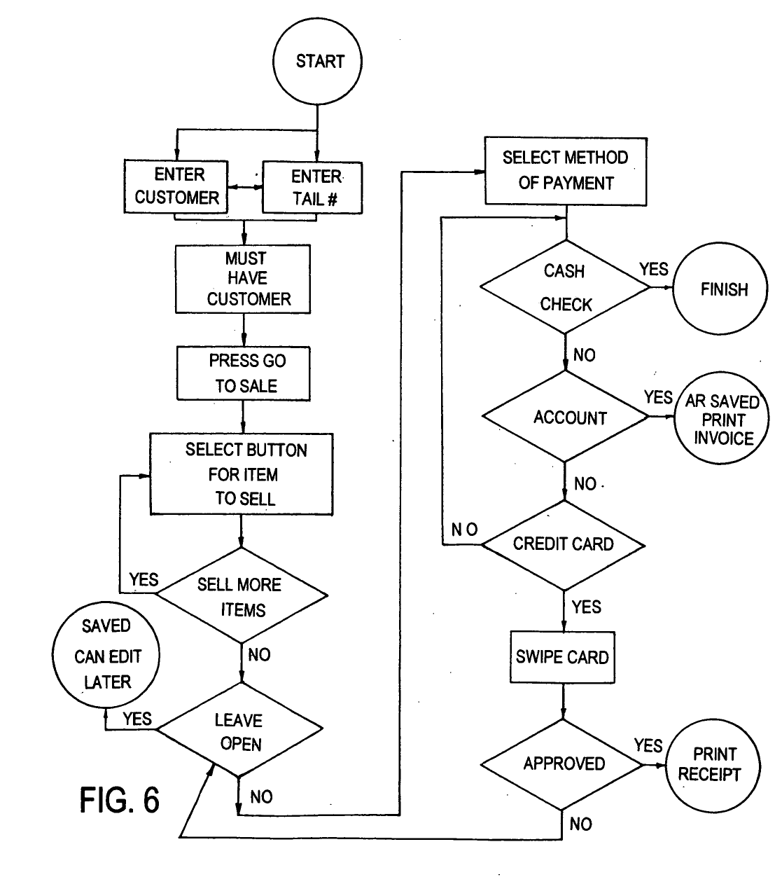

FIG. 7 is a schematic and flowchart for the host computer software and method for a typical application, such as a flight school.

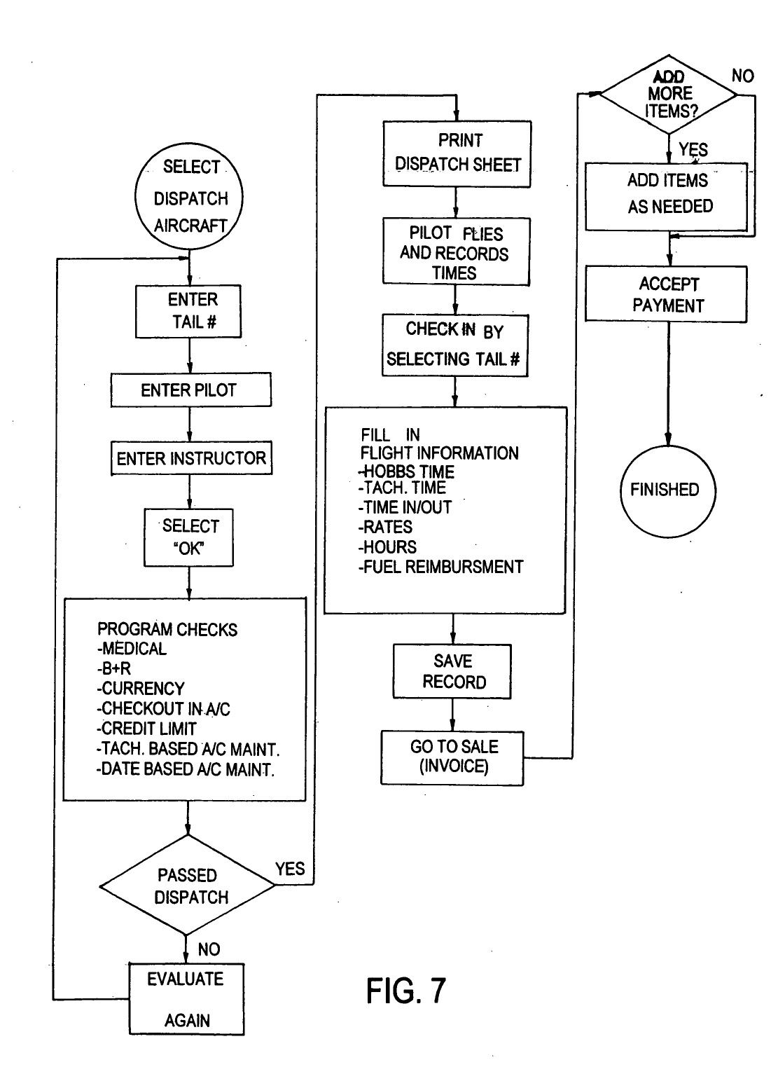

FIG. 8 is a schematic and flowchart for the host computer software and method for a typical application, such as a maintenance (A&P) shop.

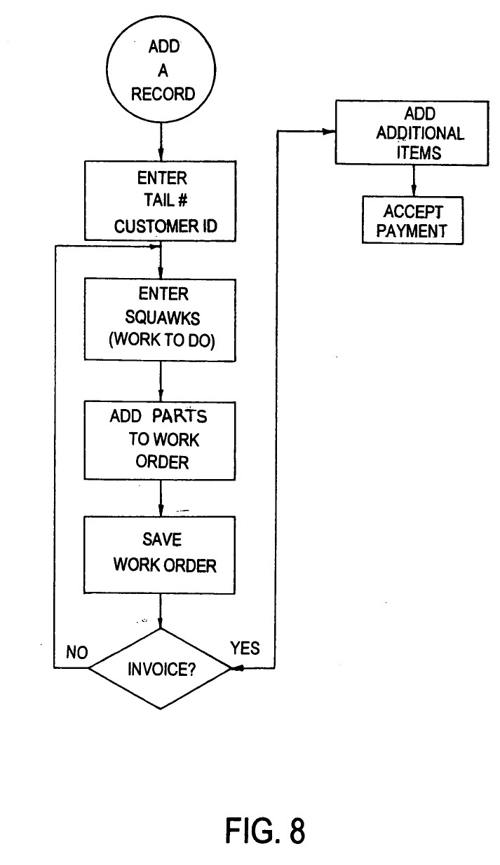

FIG. 9 is a schematic and flowchart for the host computer software (CE Receive) and method for a typical transaction via the remote input device and interaction with the database.

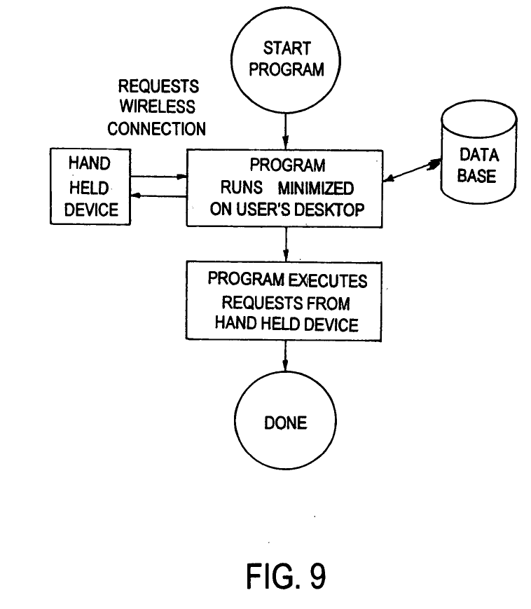

FIG. 10 is a schematic of the host computer software (FBO Manager 2004, CE Receive) and the remote input device, remote input device software (PocketFuel) and interaction with the database and each of the three software programs.

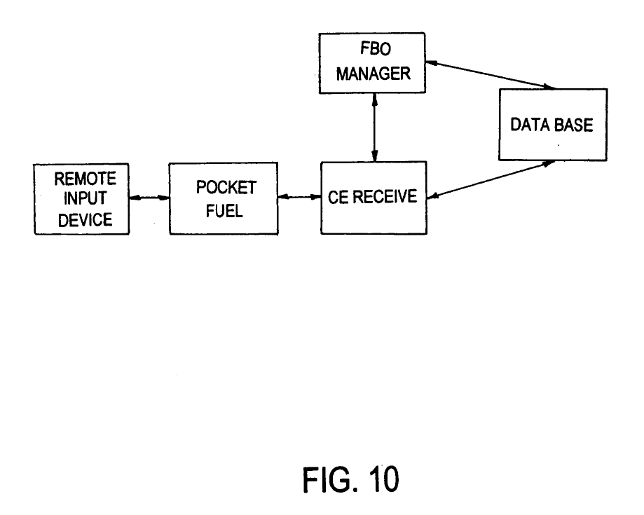

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawings, these details are not intended to limit the scope of the invention.

### DETAILED DESCRIPTION OF THE PREFERRED EMBODIMENT

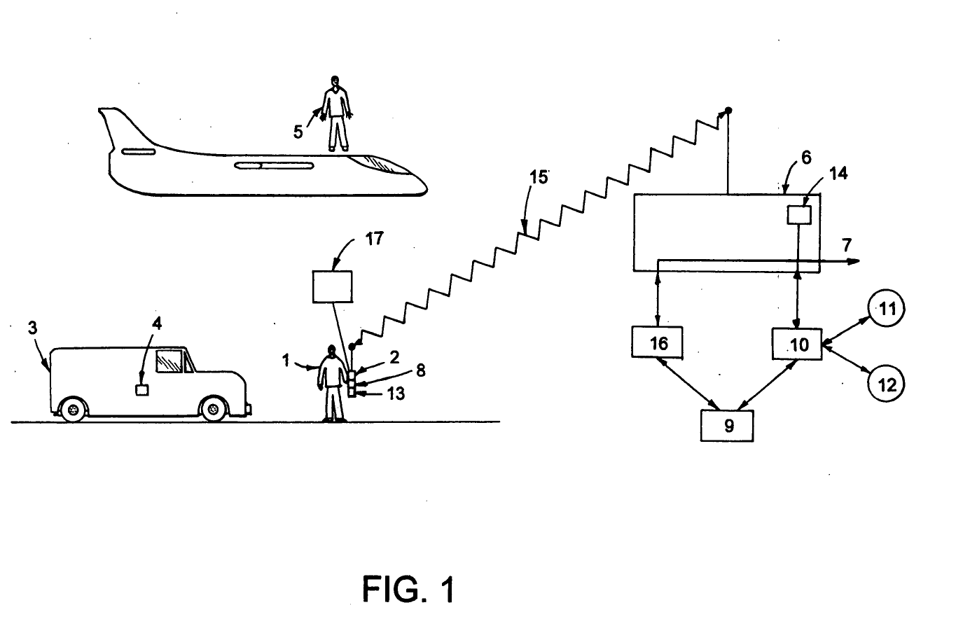

The apparatus, system and method of using the invention will now be further described and exemplified by reference to the various specific embodiments set forth in the drawings. FIG. 1 depicts in symbolic form the system components and the interaction of the components in the preferred embodiment and best mode, which will now be explained.

For example, FIG. 1 shows schematically the system components; a FBO office 6 engages a service call by a remote customer (with or without aircraft) 5 for fuel, products and/or services from the remote operator 1 (with or without fuel truck 3). All fuel, products and/or services are based in user-defined units; i.e. gallons, liters, etc. for fuel; per service rendered (i.e. auxiliary start, ramp fee, per night tie-down fee, or other user-defined criterion) and/or per product sold (quart of oil, etc. or other user-defined criterion). The customer type, purchase type and payment type of the invention may be any user/operator-defined criterion. User/operator-defined criterion is hereby defined as types of customers, purchases and/or payments (modified or unmodified by other attributes) as defined by the user or operator of the apparatus, system and method of the invention. This starts the Remote Sales Cycle (RSC). The remote operator 1 communicates via a wireless network 15 with the FBO office 6 and FBO host computer 14 (with FBO Manager 2004 software 10 and CE Receive software 16 installed) using a handheld communication input device 2 with viewing and touch-screen 8 (with PocketFuel software 17 installed). FBO Manager 2004 10, CE Receive 16 and PocketFuel 17 are computer software programs developed by this same inventor and may be used as part of the disclosed method and system herein in best mode. Some aspects of the preferred embodiment of the invention are written in Microsoft Visual Basic; one skilled in the art may use any, some or all of the following: Microsoft Visual Basic, VB.Net, Delphi, Embedded Visual Basic, Embedded Visual C++, Turbo Pascal, C#, CE.NET or any other programming tool.

Said remote input device may be a laptop computer, a Fujitsu Pencentra (a Windows CE computer using the H/PC version of Windows CE) or (in best mode) an iPAQ or another equivalent PocketPC or other suitable device. Remote at the aircraft location, the input device 2 communicates with the fuel flow counter output 4 (preferably a Veeder-Root electronically enabled fuel meter via cable or wireless) on the fuel truck 3 to record the “start” and “stop” units of measure (gallons, etc.) of fuel dispensed into remote customer's aircraft 5. All communications and means of communicating concerning the invention are either one-way (i.e. able to transmit or receive only) or two-way communications (i.e. able to transmit and receive data), as needed.

The remote input device also utilizes an remote input device printer/credit card swipe 13 (preferably the Oneil 2tSCR—a 2″ thermal transfer printer with a card swipe that supports serial communications via RS-232 or irDA or the Citizen CMP-10— also a 2″ thermal transfer printer with a card swipe that also supports serial communications via RS-232 or irDA) in communication (preferably wireless communication using Enterasys Networks “RoamAbout” R2 wireless access platform) with credit card (or other means of commerce) payment authorization and approval source 7. In the FBO office 6 the FBO host computer 14 has FBO Manager 2004 software 10, CER 16 and database 9 installed and can output user-defined reports 11 via a printer and/or interact with independent outside vendor accounting software (QuickBooks, etc., for example) for output-accounting 12 and/or via a printer.

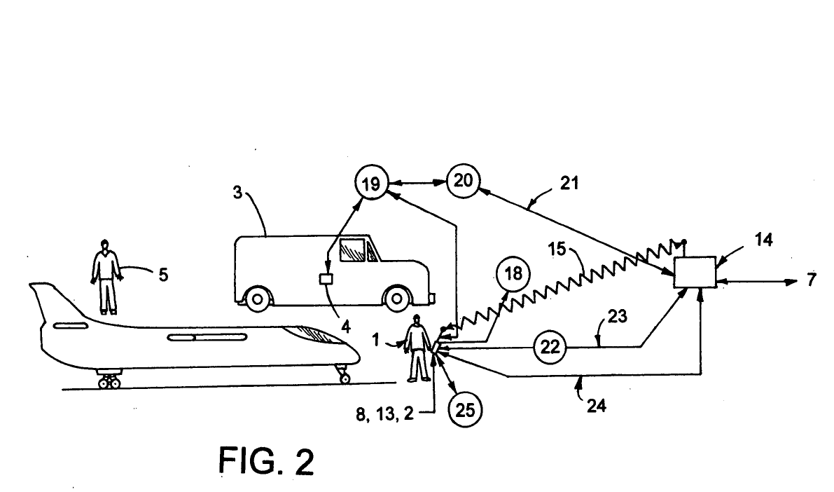

Referring now to FIG. 2, the Remote Sales Cycle (RSC) is schematically shown as viewed by the remote operator 1. The method and system invention disclosed herein allows a remote sale/payment from start to finish to be completed by the fuel truck 3 remote operator 1: 18 select/input tail number into remote input device 2; 19 manually select or talk automatically to fuel flow counter output 4; 20 record meter readings; 21 send data via wireless network 15 inside to FBO host computer 14 to get pricing, taxes, and discounts and send back data; 22 remote operator verifies information and swipes credit card; 23 data transmitted inside and sent via (in this example) credit card payment authorization and approval source 7; 24 send back approval to hand held device; 25 optionally print receipt and get remote customer's signature or obtain customer's digital signature to complete payment. For example, remote customer 5 requests 40 gallons of fuel, 2 quarts of oil and auxiliary start for her aircraft. Remote operator follows above-referenced sales procedure (using both “fuel” and “services/products” functions) and inputs aircraft N number, pumps requested fuel quantity (40 gallons), adds 2 quarts of appropriate type oil and enters the product/service ID (identification number, letter(s) or symbol) for 2 quarts oil and auxiliary start service. The remote input device communicates with and gets prices and taxes (if applicable) from FBO host computer 14 which transmits back the appropriate total amount (assume, for example, $142.53) to be paid by remote customer 5. Remote operator 1 verifies price information, swipes credit card into remote input device printer/credit card swipe 13 (or other type magnetic card able to be used for payment) which is transmitted via wireless network 15 back to FBO host computer 14 which contacts credit card payment authorization and approval source 7, obtains approval for credit card payment and sends back to remote input device 2 invoice to be printed by remote input device printer/credit card swipe 13 and signed by remote customer 5, debiting remote customer's credit card for $142.53 and crediting FBO office's merchant ACH (automated clearing house) checking account $142.53 (less the merchant processing fee). Remote operator then provides auxiliary start for remote customer's aircraft and she embarks on her next flight. Credit card payment authorization and approval source 7 (or other medium of commerce, i.e. “pay orders” and “funds transfer” per U.C.C. Article 4A, for example) and customer payment may be via modem/phone line, Internet/WWW (World Wide Web), corporate intranets, commercial networks, electronic funds transfer networks, telecommunications networks, satellite means, radio means, fiber optic cable or any other suitable medium of commerce. All data transmitted and received between the remote input device 2 and host computer 14 and/or between the host computer and/or credit card payment authorization and approval source (or other medium of commerce) may be encrypted or un-encrypted as the user desires. Payment may be made by remote (or inside) customer by cash, credit card, debit card, check, commercial account or any other type value acceptable for payment to the FBO seller. All customer types, purchase types and payment types may be based on any user-defined criterion as desired by the system's user/operator.

A customer may request any or all of the type's fuel, products or services. Thus, herein, “fuel, products and/or services” is hereby defined as any or all of at least one unit or partial unit of the type's fuel, product or service offered by the FBO office seller. For example, the customer may request only fuel, only product or only service or any combination or permutation of all or none of each of the fuel, product or service offered by the FBO seller. Whenever and/or is used in this patent application it means any combination or permutation of all, one, some, a plurality or none of each of the item or list mentioned, which is not intended to be limiting but merely for example and illustration.

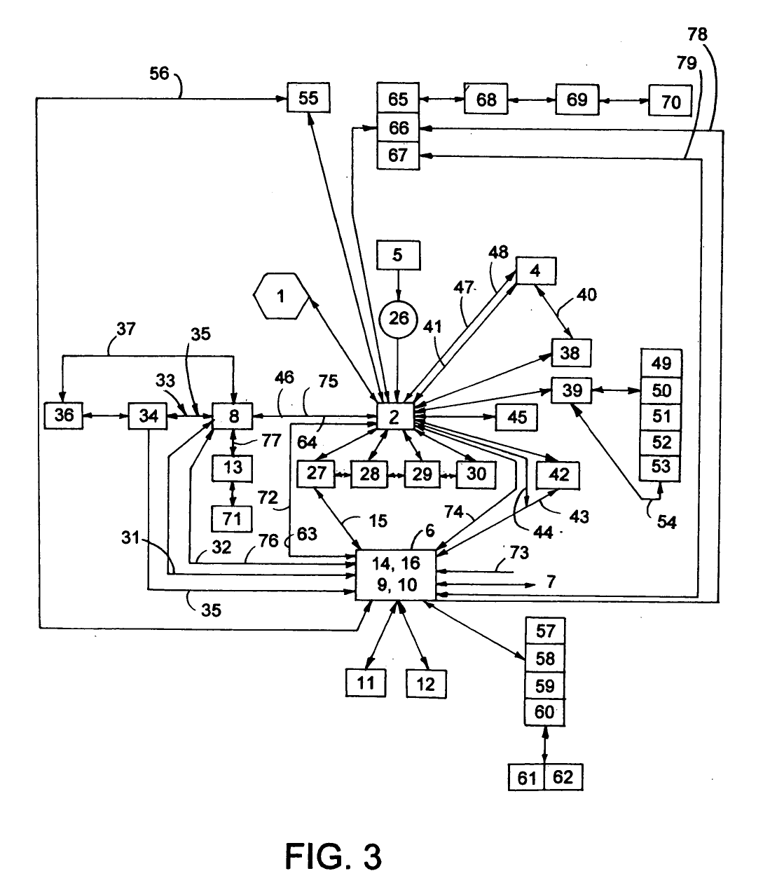

FIG. 3 depicts a schematic of the apparatus, method and system in operation relative to the components in more detail; upon request of a remote customer (with or without aircraft) 5 for fuel, products and/or services (start of sale 26), the system remote operator 1 uses input device 2 (handheld PC w/wireless capability or the like) to input aircraft's N (identification) number to initiate a “transaction” (Remote Sales Cycle) of FBO fuel, products or services. The input device 2 preferably uses a viewing/touch-screen 8 (with or without stylus) with a tabbed-and-layered screen; one tabbed “fuel” and the other layer tabbed “products” (services are treated as a type of product). Remote operator 1 is then presented with a plurality of selections (menu) on the remote input device 2. In this particular embodiment, there are 4 selections: “history” 27 (of that aircraft); “reprint receipts” 28 (of a previous transaction); “look-up” 29 (searches FAA database to identify aircraft owner, address, etc.), or; “sale” 30. Initial entry of the remote customer aircraft's 5 N number transmits the N number from the remote input device 2 via wireless network 15 to CE Receive (CER) 16 software which has been installed in the FBO host computer 14. CER 16 queries database 9 for that N number and its history of previous sales with the FBO office 6. If CER data query results in prior sales, CER 16 sends history data 31 to remote input device 2 and viewing/touch-screen 8. If no prior history data is found (i.e. a new customer), CER 16 sends message to remote input device 2 conveying “no history” 32 and remote operator 1 is presented (in this embodiment) with 2 options to search database 33; “yes” 34 (which searches database 9 via CER 16 which contains a copy of the FAA (Federal Aviation Administration) database for all known registered aircraft in the United States (US), updated regularly, and returns 35 to remote input device 2 viewing/touch-screen 8 the aircraft owner's name, address (and other pertinent information registered in the FAA database) or “no” 36 which returns to the previous screen 37.

The remote input device 2 viewing/touch-screen 8 then presents the operator with 2 options (tabbed layers): “Fuel” 38 or “Products” 39 (which includes services). “Fuel Sale” 40 enters into the remote input device 2 the fuel flow counter output 4 (via cable or wireless) “start” gallons (or liters or other unit of measure) either manually or automatically 41 (using wireless Veeder-Root Interface in the best mode). “Manual” option 42 requires the remote operator 1 to select a particular fuel meter from a plurality of fuel meters (designated by numbers or symbols). This fuel meter selection sends 43 to CER 16 to query the database 9 for that particular fuel meter last known quantity reading. CER 16 sends data 44 to remote input device 2 and uses such reading for the fuel “start” amount. Remote operator 1 then pumps desired amount of fuel into remote customer's aircraft 5 and can then manually enter ending fuel meter reading 45 or net amount pumped 45 which equals amount sold in that particular transaction and shown on viewing/touch-screen 8.

Alternately, in automatic (and best) mode with Veeder-Root electronically enabled fuel meters, the remote operator 1 selects meter as previously described, but the remote input device 2 queries the fuel meter directly 47 for the “start” amount upon activating the “start” button on the input device 2 viewing/touch-screen 8. Remote operator 1 then pumps desired amount of fuel into remote customer's aircraft 5 from the fuel truck 3 and pushes the “stop” button on the input device 2 touch-screen which enters 48 “stop” gallons amount into input device 2 automatically from fuel flow counter output 4.

Selection of “Products Sale” 39 presents the remote operator 1 with a pull-down menu of “Products/Services” (for example, ramp fee 49, catering 50, rental car 51, auxiliary start 52, etc. and oil 53, etc.). Remote operator 1 selects desired products/service designated by product ID (numerical, alphabetic, symbol, graphic or any other type designation) and the remote input device 2 defaults 54 to show quantity of “one.” Remote operator 1 may increase quantity as needed to reflect products and/or services as requested and/or purchased by the customer. It can be used either with or with out the “Fuel Sale” option.

Both “Fuel Sale” and “Products/Services Sale” options (via “Get Price” 55 button on remote input device 2 viewing screen) trigger a “Get Price” function 56 via CER 16 and database 9 to determine the customer type. For example, “commercial account,” 57 “transient aircraft,” 58 “flight school” 59 or any other type customer 60 as defined by the system user/operator (some, but not all, types are disclosed in the FBO Manager 2004 owner's, user's and other printed manuals, administrator's guide and related documents all incorporated by reference herein). CER 16 and database 9 also determines if any sales are taxable 61 or tax exempt 62. The price used for that particular sale is the price (with or without discounts and taxable/non-taxable) determined by CER 16 in conjunction with the database 9. CER 16 transmits back 63 to remote input device 2 the appropriate price, subtotal and taxes (if applicable) and displays to remote operator 1 the “Grand Total” 64 on the viewing/touch-screen 8.

The remote operator 1 then accepts payment via 3 payment options: a) “credit card” 65 b) “leave open” 66 (for future charges and/or to pay inside the FBO Office 6 or c) “direct bill” 67 (for established commercial accounts).

a) If the operator selects “credit card” from the above-referenced options, a pull down menu allows the remote operator 1 to select credit card type 68 (i.e. MasterCard, Visa, etc.). Upon selection of credit card type, the remote operator 1 pushes a button “Outside Credit Card” 69 on the remote input device 2 with viewing/touch-screen 8 which opens a message box with instructions 70 to remote operator 1, who follows said instructions. Next, the remote operator 1 swipes the appropriate credit card 71 into the remote input device printer/credit card swipe 13 and the remote input device 2 automatically sends “Grand Total” and credit card information (number, expiration date, etc.) 72 to CER 16. CER 16 and FBO Manager 2004 10 then validate the data internally in FBO host computer 14 and transmits credit card data (via appropriate hardware/software) to credit card payment authorization and approval source 7. Credit card payment authorization and approval source 7 automatically accesses the credit card merchant authority and approval verification 7 (via phone land line, Internet, radio, satellite or any other transmissions means) and obtains authorization for payment and then may, if credit card is accepted 73 and payment obtained, CER 16 transmits “OK” 74 to remote input device 2 to print a receipt immediately from the remote input device printer/credit card swipe 13 (if “yes” 75 is answered to “print receipt” request on the viewing screen) and obtain the customer's signature on the printed receipt to finish payment at that time. (CER 16 generates and formats receipt 76 and sends formatted receipt to remote input device 2, which uses the appropriate device drivers to read credit card approval data and formatted receipt to print receipt).

Another embodiment uses digital signatures on the remote input device 2 to obtain customer's signature and transmits via wireless network 15 to CER 16 to conclude the sale and payment. Typically, the remote input device 2 is coupled with the appropriate printer/credit card swipe via infrared, Bluetooth or RS 232, for example. Or, if “no” 77 is selected, payment is also charged to the remote customer's credit card, but no paper receipt is generated nor signature obtained by the remote operator 1 from remote customer 5.

b) If the operator selects “leave open,” 66 the customer's purchased fuel, products and/or services information (invoice number and message to FBO office staff that customer will pay inside) is transferred 78 to CER 16 in the FBO office 6 and engages the database 9 and FBO Manager 2004 software 10 so that the invoice may be kept open or paid inside the office by the customer to inside FBO staff (“staff”).

c) If the operator selects “direct bill,” 67 the customer account information is transferred 79 to the FBO office 6 and engages CER 16, database 9 and FBO Manager 2004 software 10 and the account may be billed to established customers as needed, generating an invoice and posts a pending account receivable in the accounting software 12.

Close-out: the system may be closed-out (all customer sales/payments reported) by either the remote operator or inside operator (staff) at times chosen by the operator or staff; every 24 hours, per staff or operator shift times or at other time intervals designated.

Output: after close-out, the system generates reports 11 containing different data such as total sales, sales by product/service category, profit, etc. for staff management review directly on the computer monitor or via computer printer and/or integrates directly into outside vendor accounting software (QuickBooks, etc.) 12 for income tax and other purposes.

To make the invention in its preferred embodiment, one skilled in the art would assemble, install and connect appropriately the following components in the ordinary and customary practice of the art (all owner's manuals, user's manuals, technical specifications and/or other printed documents available concerning the following hardware and/or software, components, peripheral devices and/or necessities are hereby incorporated by reference): The host computer may be any suitable-type computer, but the preferred hardware includes a personal computer (PC) which is a 100% IBM-compatible machine (with typical monitor, keyboard, etc.) with a Pentium processor or higher; a hard disk with at least 20 MB free space; a CD Rom Drive; a Mouse; 16 megabyte of memory (RAM); an EGA, VGA, 8514, Hercules, or compatible display; and Windows 95 or later as the FBO office “host computer;”

The following is recommended to improve system performance: extra extended memory; expanded memory; math co-processor; rninimum Pentiumn processor; 32 MB RAM;

Input device—handheld computer used by remote operator (with or with out fuel truck); two types of handheld computers are currently used, the inventor has also developed a version to support a laptop computer directly;
1) Fujitsu Pencentra; a Windows CE computer using the H/PC version of Windows CE.
2) iPAQ or another equivalent PocketPC (best mode).

The Handheld device runs a software application developed by this inventor (PocketFuel) coded in Microsoft Embedded Visual Basic 3.0. The Handheld device supports 802.11 network connections. The Handheld device has serial (Comm) port capability.

Printer at the fuel truck;
Oneil 2tSCR. A 2″ thermal transfer printer with a card swipe. Supports serial communications via RS-232 or irDA or;
(best mode) Citizen CMP-10—a 2″ thermal transfer printer with a card swipe. Supports serial communications via RS-232 or irDA. This inventor is currently (as of Jan. 20, 2004) Citizen's first beta tester for their Bluetooth version of this printer.

Electronically enabled fuel meters (best mode);
Veeder-Root is a supplier of meters for aviation fuel trucks. Veeder-Root has provided a specification to connect to their meters. The handheld input device connects to the meter via serial communications via cables or wireless networks.

Wireless networks;
Preferably, using 802.11 protocols, the handheld computer accesses the wireless network via Enterasys Networks “RoamAbout” R2 wireless access platform. At the FBO office, there is a Wireless Access Point (WAP), attached to the FBO's host computer or computer network. Data are transferred via TCP/IP. “Bluetooth” wireless protocols can be used on the handheld at the truck and can communicate via “Bluetooth” with the above-referenced Veeder-Root electronically enabled fuel meter in an alternative embodiment. Any other appropriate type wireless network, such as cell phone, radio, etc. may be used.

Software developed by this inventor “FBO Manager 2004,” “CE Receive,” and software by Microsoft, “ActiveSync” is installed inside the FBO office on the FBO host computer. Another software program developed by this inventor “PocketFuel” is installed on the handheld remote input device. All software is installed according to the developer's or manufacturer's instructions, procedures and specifications.

CE Receive is a TCP/IP listening device. The system may use other modules from FBO Manager 2004 which allows multiple locations; CE Receive manages inventory, truck names, credit card names, and communicates to process credit cards and performs other functions.

With the above components, one skilled in the art would proceed as follows:
1) Install FBO Manager 2004 on the suitable host computer or computer network (PC) capable with Windows 95 or higher;
2) Install Microsoft “ActiveSync” on the PC;
3) Put the hand-held iPAQ Pocket PC h5555 with wireless capability in the “cradle” containing USB or serial port connections;
4) Install PocketFuel applications software into iPAQ hardware per user's manuals.
5) Install CE Receive into PC per user's manuals.
6) Start CE Receive on the PC per user's manuals.
7) Locate and configure iPAQ synchronization folders per user's manuals.
8) Synchronize the iPAQ with the host computer PC.
9) Start PocketFuel on the iPAQ.
10) (First time use only/initial start)—accept default location designated by PocketFuel of synchronization.
11) Configure IP address in host computer PC (where CE Receive is running).
   System is now installed and operational.

Alternately, a customer (inside customer) may contact inside staff of the FBO office in person, via phone, facsimile (FAX), email, on-line connection, radio, pager or other means of communication. When a customer engages the FBO office in any of the above-referenced manners and requests fuel, services and/or products, the request starts an Inside Sales Cycle (ISC) by the FBO staff.

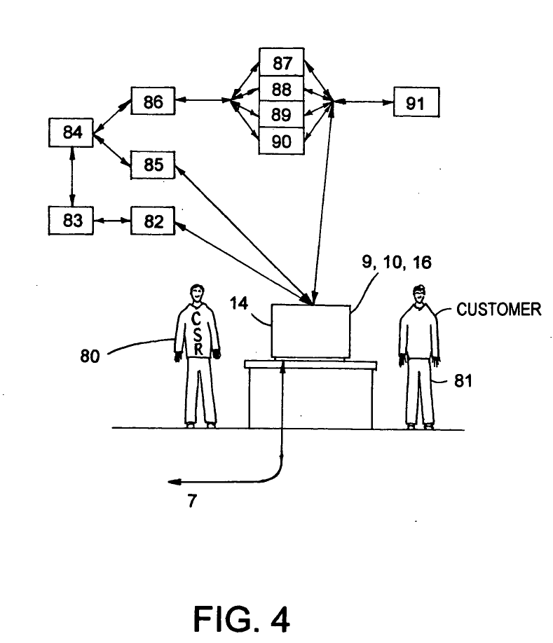

Referring now to FIG. 4, a drawing of the Inside Sales Cycle (ISC) is shown schematically as viewed by the inside operator (also referred to as “staff” or Customer Service Representative “CSR”). The inside operator 80 accepts inside customer's 81 request for fuel, services and/or products. The FBO host computer 14 (with previously described hardware specifications) is accessible to the inside operator 80 with the previously described software already installed, set-up and configured for use. Typically, FBO Manager 2004 software is the main viewing page on the monitor and preferably has the optional module “Front Desk” installed which uses Graphic User Interfaces for ease of use (GUIs).

The development and proliferation of GUIs has greatly enhanced the ease with which users interact with databases both in the searching stage and in the display of information. A conventional GUI display includes a desktop metaphor upon which one or more icons, application windows, or other graphical objects are displayed. Typically, a data processing system user interacts with a GUI display utilizing a graphical pointer, which the user controls with a graphical pointing device, such as a mouse, trackball, or joystick. For example, depending upon the actions allowed by the active application or operating system software, the user can select icons or other graphical objects within the GUI display by positioning the graphical pointer over the graphical object and depressing a button associated with the graphical pointing device. In addition, the user can typically relocate icons, application windows, and other graphical objects on the desktop utilizing the well known drag-and-drop techniques. By manipulating the graphical objects within the GUI display, the user can control the underlying hardware devices and software objects represented by the graphical objects in a graphical and intuitive manner.

User interfaces used with multi-tasking processors also allow the user to simultaneously work on many tasks at once, each task being confined to its own display window. The interface allows the presentation of multiple windows in potentially overlapping relationships on a display screen. The user can thus retain a window on the screen while temporarily superimposing a further window entirely or partially overlapping the retained window. This enables the user to divert the attention from a first window to one or more secondary windows for assistance and/or references, so that overall user interaction may be improved. There may be many windows with active applications running at once. Oftentimes, the windows may be (dynamically or statically) related such that modifying a query in one window results in changes to the displayed data in the other related windows, thereby “propagating” the changes throughout.

For this typical inside sale, the inside operator 80 (IO) would click on the “POS” (Point of Sale) button on the GUI. A screen (window) opens to “add new record” for this inside customer 81 (IC). Next, the IO would enter the IC's aircraft N number and/or customer identification (ID) (numerical, alphabetic, symbol, graphic or other type designation) if the IC is an existing customer or make a new customer ID if the IC is a new customer 82. If this is a fuel purchase, IO would push the “fuel” GUI button (which shows fuel truck/meter selections) and enter “start” and “stop” selected meter readings to determine amount sold 83. From a pull-down menu on the FBO Manager main viewing page, the IO may sell (add to IC's purchase) all other desired products/services requested by IC via product/service ID (numerical, alphabetic, symbol, graphic or other type designation) 84, per user's manual instructions.

When all fuel, products and/or services desired by IC are sold per above actions, the IO activates “enter (save invoice)”, the IO is presented (in this embodiment) 2 options: “pay later” 85 (which keeps invoice open for future sales) or “accept payment” 86. “Accept payment” offers (in this embodiment) 4 choices; “cash” 87, “credit card” 88, “check” 89, or “on account” 90. Payment is then accepted from the IC per the above choices, 91 and that transaction (invoice) is stored in the database 9 and the system returns to the FBO Manager 2004 software main viewing page. One embodiment of the invention eliminates the conventional “card processor” hardware/software (i.e. Veriphone, etc.) commonly used and replaces it with FBO Manager 2004 software, modem and a magnetic card reader (commonly referred to as a “swiper”).

To make this aspect of the invention, one skilled in the art would first install/load the FBO Manager 2004 software into the FBO host computer 14. Then one would set-up the, chart of accounts (general ledger). Next, one would set-up desired items to be sold; fuel/services/products with each associated/designated ID. Additional sub-modules with specific input/display and product/service ID codes, for example, aircraft rental, labor, parts, etc. (as disclosed in the previously incorporated manuals) may be added as well as other FBO profit centers (flight school, A&P shop, charter flights, etc. for example). Then one would configure applicable (or non-applicable) taxes and/or other fees/charges. Next, the customer base (existing, valued, new or other user-defined type customer) would be configured. Lastly, special prices/discounts are configured on user-defined criteria (type customer, quantity, old inventory, etc.). Another embodiment allows multiple site locations. At this point, the inside sales apparatus, system and method is fuily operational.

Further explanation of the use of the system follows. The “main page” has a blank screen but in best mode uses the “Front Desk” module (allowing touch-screen or mouse interaction) to allow access to the invention's features. For example, in this embodiment, the “File” pull-down menu offers the user a plurality of options such as “new access database,” “open access database,” “open SQL database,” “enter password,” “log out,” “configure business (which contains nine sub-group items),” “system maintenance,” “unload (close) database,” and “exit.”

The “POS” (point of sale) menu opens a form to make data entry easier for the inside operator.

The “Operations” menu offers “shop orders (which contains a plurality of sub-group items),” “quote flight,” “search parts/price,” “tail number on-field tracking,” “recurring items (which contains a plurality of sub-group items),” and “invoice related reports (which contains a plurality of sub-group items).”

The “Inventory/Accounting” menu offers “inventory (which contains a plurality of sub-group items),” “leaseback (which contains a plurality of sub-group items),” “customer account management (which contains a plurality of sub-group items),” “chart of accounts (which contains a plurality of sub-group items),” and “applied tax relationships (which contains a plurality of sub-group items).”

The “Concierge” menu offers “new reservation,” “view reservation,” “reports (which contains a plurality of sub-group items),” and “configure.”

The “Fuel Management” menu offers “fuel transfers and purchases,” “physical stock readings,” “recirculation/filter entry,” “launch FuelSentry! (which tracks all fuel inventory),” “reports (which contains a plurality of sub-group items),” “edit readings (which contains a plurality of sub-group items),” and “configuration.”

The “Flight Activities” menu offers “set-up block plans (which contains a plurality of sub-group items),” “dispatch (which contains a plurality of sub-group items),” “edit/add flights (which contains a plurality of sub-group items),” “flight reports (which contains a plurality of sub-group items),” “pilots (which contains a plurality of sub-group items),” “pilot currency (which contains a plurality of sub-group items),” “flight instructors (CFI) (which contains a plurality of sub-group items),” “flight school aircraft (which contains a plurality of sub-group items),” and two options concerning student pilots—“objectives” and “grades.”

The “Set-Up” menu offers “customers (which contains a plurality of sub-group items),” “suppliers,” “mechanics,” and “discount codes.”

The “Reports” menu offers “aircraft (which contains a plurality of sub-group items),” “pilots (which contains a plurality of sub-group items),” “instructors (which contains a plurality of sub-group items),” “accountant report,” “customer info,” “sales reports (which contains a plurality of sub-group items),” “inventory,” “suppliers and customer lists,” “user ID/security lists,” “user defined reports (which contains a plurality of sub-group items),” and “edit/save queries.”

The “Help” menu offers “manual,” “load navigator,” “tip of the day,” “calculator,” “special maintenance functions,” “send database (sends to inventor the user's database to assist with trouble-shooting user problems),” “get version numbers,” “language selection (allows the system to be used in other languages other than English; German, Spanish, etc., for example),” and “about (general information of various aspects of the system).”

The above-referenced menus, lists, options, functions, instructions, commands, sub-commands, applications, interactions, items, products, services, fuel, groups and sub-groups are merely intended as illustration and examples, and are not intended by the inventor to in any way limit the addition, deletion or modification of any said menus, lists, options, functions, instructions, commands, sub-commands, applications, interactions, items, products, services, fuel, groups and sub-groups as might be desirable or useful to someone skilled in the art.

As will be apparent to persons skilled in the art, such as computer software programmer in the FBO aviation industry, various modifications and adaptations of the structure and method of use above-described will become readily apparent without departure from the spirit and scope of the invention, the scope of which is defined in the claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention are well known by those skilled in the art. Instead, the invention is limited and defined solely by the following claims.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

A customer may request any or all of the types of fuel or products or services. Thus, herein, “fuel, products and/or services” is hereby defined as any or all of at least one unit or partial unit of the types of fuel, product or service offered by the FBO office seller. For example, the customer may request only fuel, only product or only service or any combination or permutation of all or none of each of the fuel, product or service offered by the FBO seller. Whenever and/or is used in the following claims, it means any combination or permutation of all, one, some, a plurality or none of the units of each item or list mentioned, which is not intended to be limiting but merely for example and illustration.

1. A method for real-time FBO management operations at an airport between an aircraft customer and a FBO office, comprising:
(a) remotely initiating a transaction for a purchase by an aircraft customer comprising receiving customer identification information and communicating said customer identification information to a host processor at a FBO office;
(b) determining customer type based on said customer identification information;
(c) remotely selecting purchase type;
(d) calculating a price for said purchase based on purchase type and customer type;
(e) selecting payment type for said purchase; and
(f) accepting payment for said purchase based on payment type.

2. The method of claim 1 wherein said customer type comprises one of commercial account, transient aircraft, flight school, or any other user/operator-defined criterion.

3. The method of claim 1 wherein said purchase type comprises fuel purchase or non-fuel purchase.

4. The method of claim 1 wherein said payment type comprises one of credit card, open account, direct bill, cash, check or any other medium of commerce for any payment type from aircraft customer acceptable to said FBO office.

5. The method of claim 1 wherein customer identification information comprises an aircraft identification number or any other user/operator-defined criterion.

6. The method of claim 3 wherein said non-fuel purchase comprises products or services.

7. The method of claim 3 wherein step (c) further comprises receiving a start unit amount when said purchase type is fuel purchase.

8. The method of claim 3 wherein step (c) further comprises receiving a stop unit amount when said purchase type is fuel purchase.

9. The method of claim 3 wherein step (d) further comprises determining the price using taxable or tax-exempt status.

10. The method of claim 3 wherein step (d) further comprises determining the price using an appropriate pre-determined customer discount or any other user/operator-defined criterion.

11. The method of claim 4 wherein said payment type selection is limited by said customer type.

12. The method of claim 4 further comprising automatically accessing credit card verification and obtaining authorization when said payment type of credit card is selected.

13. The method of claim 4 further comprising storing an invoice for said purchase at the FBO office when said payment type of open account is selected.

14. The method of claim 4 further comprising billing the customer's account when said payment type of direct bill is selected.

15. The method of claim 4 further comprising generating a receipt when receiving cash, check or any other medium of commerce for any payment type from aircraft customer acceptable to said FBO office.

16. The method of claim 1 further comprising said transaction initiated inside said FBO office and said customer identification information, purchase type and payment type selection is inputted directly to said host processor.

17. A system for real-time FBO management operations at an airport between an aircraft customer and a FBO office, comprising:
a remote device in communication with a central host processor for
(a) remotely initiating a transaction for a purchase by an aircraft customer comprising receiving customer identification information and communicating said customer identification information to a host processor at a FBO office;
(b) determining customer type based on said customer identification information;
(c) remotely selecting purchase type;
(d) calculating a price for said purchase based on purchase type and customer type;
(e) selecting payment type for said purchase; and
(f) accepting payment for said purchase based on payment type.

18. The system of claim 17 wherein said customer type comprises one of commercial account, transient aircraft, flight school, or any other user/operator-defined criterion.

19. The system of claim 17 wherein said purchase type comprises fuel purchase or non-fuel purchase.

20. The system of claim 17 wherein said payment type comprises one of credit card, open account, direct bill, cash, check or any other medium of commerce for any payment type from aircraft customer acceptable to said FBO office.

21. The system of claim 17 wherein customer identification information comprises an aircraft identification number or any other user/operator-defined criterion.

22. The system of claim 19 wherein said non-fuel purchase comprises products or services.

23. The system of claim 19 wherein step (c) further comprises receiving a start unit amount when said purchase type is fuel purchase.

24. The system of claim 19 wherein step (c) further comprises receiving a stop unit amount when said purchase type is fuel purchase.

25. The system of claim 17 wherein step (d) further comprises determining the price using taxable or tax-exempt status.

26. The system of claim 17 wherein step (d) further comprises determining the price using appropriate pre-determined customer discount or any other user/operator-defined criterion.

27. The system of claim 17 wherein said payment type selection is limited by said customer type.

28. The system of claim 20 further comprising automatically accessing credit card verification and obtaining authorization when said payment type of credit card is selected.

29. The system of claim 20 further comprising storing an invoice for said purchase at the FBO office when said payment type of open account is selected.

30. The system of claim 20 further comprising billing the customer's account when said payment type of direct bill is selected.

31. The system of claim 20 further comprising generating a receipt when receiving cash, check or any other medium of commerce for any payment type from aircraft customer acceptable to said FBO office.

32. The system of claim 17 further comprising said transaction initiated inside said FBO office and said customer identification information, purchase type and payment type selection is inputted directly to said host processor.

33. A system for real-time FBO management operations at an airport between an aircraft customer and a FBO office, comprising:
a remote device in communication with a central host processor with
(a) a means for remotely initiating a transaction for a purchase by an aircraft customer comprising receiving customer identification information and communicating said customer identification information to a host processor at a FBO office;
(b) a means for determining customer type based on said customer identification information;
(c) a means for remotely selecting purchase type;
(d) a means for calculating a price for said purchase based on purchase type and customer type;
(e) a means for selecting payment type for said purchase; and
(f) a means for accepting payment for said purchase based on payment type.

34. The system of claim 33 wherein said customer type comprises one of commercial account, transient aircraft, flight school, or any other user/operator-defined criterion.

35. The system of claim 33 wherein said purchase type comprises fuel purchase or non-fuel purchase.

36. The system of claim 33 wherein said payment type comprises one of credit card, open account, direct bill, cash, check or any other medium of commerce for any payment type from aircraft customer acceptable to said FBO office.

37. The system of claim 33 wherein customer identification information comprises an aircraft identification number or any other user/operator-defined criterion.

38. The system of claim 33 wherein said non-fuel purchase comprises products or services.

39. The system of claim 33 wherein step (c) further comprises receiving a start gallons amount when said purchase type is fuel purchase.

40. The system of claim 33 wherein step (c) further comprises receiving a stop gallons amount when said purchase type is fuel purchase.

41. The system of claim 33 wherein step (d) further comprises determining the price using taxable or tax-exempt status.

42. The system of claim 33 wherein step (d) further comprises determining the price using appropriate pre-determined customer discount or any other user/operator-defined criterion.

43. The system of claim 33 wherein said payment type selection is limited by said customer type.

44. The system of claim 36 further comprising automatically accessing credit card verification and obtaining authorization when said payment type of credit card is selected.

45. The system of claim 36 further comprising storing an invoice for said purchase at the FBO office when said payment type of open account is selected.

46. The system of claim 36 further comprising billing the customer's account when said payment type of direct bill is selected.

47. The system of claim 36 further comprising generating a receipt when receiving cash, check or any other medium of commerce for any payment type from aircraft customer acceptable to said FBO office.

48. The, system of claim 33 further comprising said transaction initiated inside said FBO office and said customer identification information, purchase type and payment type selection is inputted directly to said host processor.

49. An apparatus for real-time FBO management operations at an airport between an aircraft customer and a FBO office, comprising:
a remote device in communication with a central host processor.

50. The apparatus in claim 49 further comprising a means for remotely initiating a transaction for a purchase by an aircraft customer comprising receiving customer identification information and communicating said customer identification information to a host processor at a central FBO office.

51. The apparatus of claim 49 further comprising a means for determining customer type based on said customer identification information or other user/operator-defined criterion.

52. The apparatus of claim 49 further comprising a means for remotely selecting purchase type.

53. The apparatus of claim 49 further comprising a means for calculating a price for said purchase based on purchase type and customer type.

54. The apparatus of claim 49 further comprising a means for selecting payment type for said purchase.

55. The apparatus of claim 49 further comprising a means for accepting payment for said purchase based on payment type.

56. The apparatus of claim 51 further comprising wherein said customer type comprises one of commercial account, transient aircraft, flight school or any other user/operator-defined criterion.

57. The apparatus of claim 52 further comprising wherein said purchase type comprises fuel purchase or non-fuel purchase.

58. The apparatus of claim 54 further comprising wherein said payment type comprises one of credit card, open account, direct bill, cash, check or any other medium of commerce acceptable to said FBO office.

59. The apparatus of claim 50 further comprising wherein customer identification information comprises an aircraft identification number or any other user/operator-defined criterion.

60. The apparatus of claim 57 further comprising wherein said non-fuel purchase comprises products or services.

61. The apparatus of claim 57 further comprising a means for receiving a start gallons amount when said purchase type is fuel purchase.

62. The apparatus of claim 57 further comprising a means for receiving a stop gallons amount when said purchase type is fuel purchase.

63. The apparatus of claim 53 further comprising a means for determining the price using taxable or tax-exempt status.

64. The apparatus of claim 53 further comprising a means for determining the price using appropriate pre-determined customer discount or any other user/operator-defined criterion.

65. The apparatus of claim 54 further comprising wherein said payment type selection is limited by said customer type.

66. The apparatus of claim 58 further comprising a means for automatically accessing credit card verification and obtaining authorization when said payment type of credit card is selected.

67. The apparatus of claim 58 further comprising a means for storing an invoice for said purchase at the FBO office when said payment type of open account is selected.

68. The apparatus of claim 58 further comprising a means for billing the customer's account when said payment type of direct bill is selected.

69. The apparatus of claim 58 further comprising generating a receipt when receiving cash, check or any other medium of commerce for any payment type from aircraft customer acceptable to said FBO office.

70. The apparatus of claim 50 further comprising said transaction initiated inside said FBO office and said customer identification information, purchase type and payment type is inputted directly to said host processor.

71. An apparatus for real-time FBO management operations at an airport between an aircraft customer and a FBO office comprising:
at least one remote input device further comprising a sufficient amount of computer hardware, software, peripherals and necessities outside the FBO office capable of communicating with at least one host computer further comprising a sufficient amount of computer hardware, software, peripherals and necessities inside the FBO office;
at least one database accessible to the host computer and the remote input device;
a means for communicating in real-time between the remote input device and the host computer, and;
a means for communicating in real-time between the host computer and a credit card payment authorization and/or approval source and/or any other medium of commerce for any payment type from aircraft customer acceptable to seller, the FBO office.

72. The apparatus of claim 71 further comprising a data interface and means of communicating between said remote input device and at least one fuel flow counter output, either in real-time or not.

73. The apparatus of claim 71 wherein said remote input device further comprises a viewing and touch-screen.

74. The apparatus of claim 71 wherein said remote input device further comprises a printer and credit card or any other type magnetic card swiper.

75. The apparatus of claim 71 wherein said means for communicating in real-time between the remote input device and the host computer comprises a wireless network.

76. The apparatus of claim 72 wherein the means of communicating between said remote input device and said fuel flow counter output comprises a wireless network.

77. The apparatus of claim 71 wherein the host computer further comprises a computer network accessible to and in communication with a plurality of computers, either wired or wireless.

78. The apparatus of claim 72 wherein all data and means for communication are encrypted or un-encrypted.

79. The apparatus of claim 77 wherein all data and means for communication are encrypted or un-encrypted.

80. A method for real-time FBO management operations at an airport between an aircraft customer and a FBO office, said method comprising the steps of:
(a) receiving a request from an aircraft customer to purchase at least one unit of fuel, product and/or service to a remote operator outside the FBO office;
(b) selling and providing to the aircraft customer from the remote operator the requested fuel, product and/or service;
(c) communicating with a host computer and database inside the FBO office by the remote operator via a remote input device to obtain pricing, taxing, discount information and/or other information, if applicable, regarding the requested fuel, product and/or service;
(d) accepting payment, subject to authorization and/or approval, by the remote operator either personally or via the remote input device in communication with the host computer via any medium of commerce, including cash, or credit card, debit card, check, commercial account or any other type value for payment acceptable to seller FBO office for the requested fuel, product and/or service from the aircraft customer;
(e) communicating with the host computer inside the FBO office by the remote operator via the remote input device to receive authorization and/or approval of said payment from the appropriate payment authorization and/or approval source and/or medium of commerce;
(f) accepting authorized and/or approved payment, if authorized and/or approved, by the remote operator either personally or via the remote input device;
(g) obtaining written signature on printed receipt or digital signature or other type approval method from aircraft customer to certify payment received by the remote operator either personally or via the remote input device and/or medium of commerce, whereby the sale, payment, billing and/or accounting of the transaction is accomplished in real-time.

81. The method of claim 80, said method further comprising the steps of:
(a) receiving a request from an aircraft customer to purchase at least one unit of fuel, product and/or service to an inside operator inside the FBO office;
(b) selling and providing to the aircraft customer the requested fuel, product and/or service;
(c) communicating with the database inside the FBO office by the inside operator via said host computer to obtain pricing, taxing, discount information and/or other information, if applicable, regarding the requested fuel, product and/or service;
(d) accepting payment, subject to authorization and/or approval, by the inside operator either personally or via the host computer in communication with any medium of commerce, including cash, or credit card, debit card, check, commercial account or any other type value for payment acceptable to seller FBO office for the requested fuel, product and/or service from the aircraft customer;
(e) communicating by the inside operator with the host computer inside the FBO office to receive authorization and/or approval of said payment from the appropriate payment authorization and/or approval source and/or medium of commerce;
(f) accepting authorized and/or approved payment, if authorized and/or approved, by the inside operator either personally or via the host computer;
(g) obtaining written signature on printed receipt or digital signature or other type approval method from aircraft customer to certify payment received by the inside operator either personally or via host computer and medium of commerce, whereby the sale, payment, billing and/or accounting of the transaction is accomplished in real-time.

82. A system for real-time FBO management operations at an airport between an aircraft customer and a FBO office comprising:
at least one remote input device further comprising a sufficient amount of computer hardware, software, peripherals and necessities outside the FBO office capable of communicating with at least one host computer further comprising a sufficient amount of computer hardware, software, peripherals and necessities inside the FBO office;
at least one database accessible to the host computer and the remote input device;
a means for communicating in real-time between the remote input device and the host computer, and;
a means for communicating in real-time between the host computer and a credit card payment authorization and/or approval source and/or other medium of commerce payment system for any payment type from aircraft customer acceptable to seller, the FBO office, whereby the sale, payment, billing and/or accounting of the transaction via the remote input device is accomplished in real-time.

83. The system of claim 82 further comprising a data interface and means of communicating between said remote input device and at least one fuel flow counter output, either in real-time or not.

84. The system of claim 82 wherein said remote input device further comprises a viewing and touch-screen.

85. The system of claim 82 wherein said remote input device further comprises a printer and credit card or other type magnetic card swiper.

86. The system of claim 82 wherein said means for communicating in real-time between the remote input device and the host computer comprises a wireless network.

87. The system of claim 83 wherein the means of communicating between said remote input device and said fuel flow counter output comprises a wireless network.

88. The system of claim 82 wherein the host computer further comprises a computer network accessible to and in communication with a plurality of computers, either wired or wireless.

89. The system of claim 82 wherein all data and means for communication are encrypted or un-encrypted.

90. The system of claim 83 wherein all data and means for communication are encrypted or un-encrypted.
